(19) United States
(12) Patent Application Publication
(10) Pub. No.: US 2005/0207711 A1
(43) Pub. Date: Sep. 22, 2005

(54) Optical termination pedestal

(76) Inventors: Chanh C. Vo, Mansfield, TX (US); John J. Bradley, Euless, TX (US); Scott C. Burns, Keller, TX (US); Guy Castonguay, Ft. Worth, TX (US); Donnie R. Clapp JR., Ft. Worth, TX (US); Terry D. Cox, Keller, TX (US); Liem H. Higa, Dallas, TX (US); Steven R. Sims, Denton, TX (US); Harley J. Staber, Coppell, TX (US); Kevin L. Strause, Keller, TX (US)

Correspondence Address: CORNING CABLE SYSTEMS LLC, P O BOX 489, HICKORY, NC, 28603, US

(21) Appl. No.: 10/804,958

(22) Filed: Mar. 19, 2004

(51) Int. Cl. G02B 6/36; G02B 6/00

(52) U.S. Cl. 385/94; 385/88; 385/92; 385/135; 385/139; 385/134; 340/870.28

(57) ABSTRACT

An optical termination pedestal defines an interior cavity for interconnecting an optical fiber of a distribution cable and an optical fiber of a drop cable. The pedestal includes a base, a housing positioned over the base, and a plate secured to the housing or the base. The plate separates the interior cavity into a first compartment and a second compartment and has at least one cable port for routing the distribution cable into the first compartment. At least one connector port may be provided on the plate for receiving a connectorized optical fiber of the distribution cable from the first compartment and a pre-connectorized drop cable from the second compartment. The plate is provided with an O-ring to seal the first compartment relative to the second compartment. As a result, a sealed splice closure is created within the interior cavity without the need for a separate enclosure.

### BACKGROUND OF THE INVENTION

1. Field of the Invention

The present invention relates generally to a pedestal adapted for use in a fiber optic communications network, and more specifically, to an optical termination pedestal adapted for interconnecting an optical fiber of a distribution cable and an optical fiber of a fiber optic drop cable within an interior cavity defined by the pedestal.

2. Description of the Related Art

Optical fiber is increasingly being used for a variety of broadband applications including voice, video and data transmissions. As a result of the ever-increasing demand for broadband communications, fiber optic networks typically include a large number of mid-span access locations at which one or more optical fibers are branched from a distribution cable. These mid-span access locations provide a branch point from the distribution cable leading to an end user, commonly referred to as a subscriber, and thus, may be used to extend an “all optical” communications network closer to the subscriber. In this regard, fiber optic networks are being developed that deliver “fiber-to-the-curb” (FTTC), “fiber-to-the-business” (FTTB), “fiber-to-the-home” (FTTH), or “fiber-to-the-premises” (FTTP), referred to generically as “FTTx.” Based on the increased number of mid-span access locations and the unique demands of the optical fibers and optical connections, optical termination pedestals are needed for routing, protecting, and managing optical fibers and optical connections in an FTTx network. Optical termination pedestals are also needed for interconnecting optical fibers branched from the distribution cable with optical fibers of fiber optic drop cables at locations that are readily accessible to a craftsperson. Thus, it would be desirable in an FTTx network to provide an optical termination pedestal that is operable to interconnect an optical fiber of a feeder cable, distribution cable or branch cable with an optical fiber of a fiber optic drop cable in a substantially sealed environment at a readily accessible location.

In one example of a fiber optic communications network, one or more drop cables are interconnected with a distribution cable at a mid-span access location. Substantial expertise and experience are required to configure the optical connections in the field. In particular, it is often difficult to identify an optical fiber of the distribution cable to be interconnected with an optical fiber of a particular drop cable. Once identified, the optical fibers of the drop cables are typically joined directly to the optical fibers of the distribution cable at the mid-span access location using conventional splicing techniques, such as fusion splicing. In other instances, the optical fibers of the drop cables and the optical fibers of the distribution cable are first spliced to a short length of optical fiber having an optical connector mounted on the other end, referred to in the art as a “pigtail.” The pigtails are then routed to opposite sides of a connector adapter sleeve to connect the drop cable to the distribution cable. In either case, the process of configuring the mid-span access location is not only time consuming, but frequently must be accomplished by a highly skilled field technician at significant cost and under field working conditions that are less than ideal. In networks in which a mid-span access location is enclosed within a splice closure, reconfiguring the optical fiber connections in the splice closure is especially difficult, based in part on the inaccessible location of the closure and the inability to readily remove the closure from the distribution cable. Further, once the optical connections are made, it is often labor intensive, and therefore costly, to reconfigure the existing optical connections or to add additional optical connections.

In order to reduce costs by permitting less experienced and less skilled technicians to perform optical connections and reconfigurations at mid-span access locations in the field, communications service providers are increasingly pre-engineering new fiber optic networks and demanding factory-prepared interconnection solutions, commonly referred to as “plug-and-play” type systems. Pre-engineered networks, however, require that the location of at least some of the branch points in the network be predetermined prior to the distribution cable being deployed. More particularly, pre-engineered solutions require precise location of the factory-prepared mid-span access locations where the preterminated, and sometimes pre-connectorized, optical fibers of the distribution cable are made available for interconnection with optical fibers of drop cables extending from the subscriber premises. Thus, with regard to a factory-prepared interconnection solution, it would be desirable to provide an optical termination pedestal in which optical fibers of a plurality of drop cables can be readily connected to optical fibers branched from a distribution cable. It would also be desirable to provide an optical termination pedestal having one or more connector ports located within an interior cavity defined by the pedestal and operable for receiving a connectorized optical fiber of the distribution cable on one side of the connector port and a pre-connectorized fiber optic drop cable on the other side of the connector port. It would further be desirable to provide an optical termination pedestal for use in a pre-engineered FTTx network that can be readily accessed and reconfigured after installation by a less experienced and less skilled field technician.

### BRIEF SUMMARY OF THE INVENTION

To achieve the foregoing and other objects, and in accordance with the purpose of the present invention as embodied and broadly described herein, the present invention provides various embodiments of an optical termination pedestal including a housing configured as a “canister” or “butt” type closure that may be mounted onto a conventional pedestal base or onto a base incorporated into a below-grade vault or hand hole. A plate disposed within the housing is provided with a seal between the housing and the periphery of the plate. The plate may serve as a bulkhead with one or more connector ports mounted on the plate for receiving a connectorized optical fiber of a distribution cable on one side of the connector port and a pre-connectorized fiber optic drop cable on the other side of the connector port. The plate also has one or more cable entrance and exit ports for routing the distribution cable and any fiber optic drop cables utilized in forming optical connections, for example, by fusion splicing or by interconnecting pigtails through a connector adapter sleeve. The plate separates the interior cavity of the optical termination pedestal into a first compartment for managing terminated optical fibers and optical connections and a second compartment for receiving the distribution cable and the drop cables. Advantageously, the plate substantially seals the first compartment relative to the second compartment and thereby prevents moisture from entering the first compartment, for example in the event of a flood condition. An optical termination pedestal according to the present invention permits a field technician to establish desired optical connections in a fiber optic communications network and to reconfigure optical connections after initial installation of the pedestal at a convenient mid-span access location along the length of a feeder cable, a distribution cable or a branch cable of a fiber optic network.

In an exemplary embodiment, the present invention provides an optical termination pedestal defining an interior cavity for housing fiber optic cables, optical fibers and optical connections. The optical termination pedestal includes a base, a housing positioned over the base, a distribution cable received within the interior cavity, at least one drop cable received within the interior cavity, and a means for interconnecting at least one optical fiber of the distribution cable with at least one optical fiber of at least one drop cable. The optical termination pedestal further includes a plate disposed within the interior cavity that separates the interior cavity into a first compartment and a second compartment and is operable to substantially seal the first compartment relative to the second compartment. The plate also provides one or more cable ports for routing at least one of the distribution cable and the drop cable into the first compartment. At least one optical fiber is branched, also referred to herein as “terminated,” from the distribution cable in the first compartment and is optically connected by the means for interconnecting to at least one optical fiber of a fiber optic drop cable in the first compartment or in the second compartment.

In yet another exemplary embodiment, the present invention provides an optical termination pedestal defining an interior cavity for forming optical fiber connections. The optical termination pedestal comprises a base for locating the pedestal in the ground, a housing positioned over the base, a distribution cable received within the interior cavity, at least one drop cable received within the interior cavity and a mounting plate disposed within the interior cavity that operates to separate the interior cavity into a first compartment and a second compartment and further operates to substantially seal the first compartment relative to the second compartment. Terminated and connectorized optical fibers of the distribution cable in the first compartment are optically connected to one side of the connector ports mounted on the mounting plate, while one or more pre-connectorized fiber optic drop cables in the second compartment are optically connected to the other side of the connector ports.

In yet another exemplary embodiment, the present invention provides an optical termination pedestal for use at a branch point, such as a mid-span access location, in a fiber optic communications network. The optical termination pedestal defines an interior cavity and comprises a base, a housing positioned over the base and a plate disposed within the interior cavity. The plate is operable for separating the interior cavity into a first compartment and a second compartment and for substantially sealing the first compartment relative to the second compartment. The plate also defines one or more cable entrance and exit ports for routing the distribution cable into and out of the first compartment and for routing at least one drop cable into the first compartment. At least one terminated optical fiber of the distribution cable in the first compartment is optically connected to an optical fiber of at least one drop cable in the first compartment. Alternatively, at least one terminated optical fiber of the distribution cable in the first compartment may be first connectorized and then optically connected to a pre-connectorized fiber optic drop cable in the first compartment through an interconnection means, such as a conventional connector adapter sleeve.

### BRIEF DESCRIPTION OF THE DRAWINGS

These and other features, aspects and advantages of the present invention are better understood when the following detailed description of the invention is read with reference to the accompanying drawings, wherein:

FIG. 1 is a perspective view of an optical termination pedestal defining an interior cavity and including a base, a housing positioned over the base, a mounting plate disposed within the interior cavity and secured to the housing, and a pre-connectorized fiber optic drop cable optically connected to a connectorized optical fiber of a distribution cable through a connector port mounted on the mounting plate in accordance with an exemplary embodiment of the present invention;

FIG. 2 is a perspective view of an optical termination pedestal defining an interior cavity and including a base, a removable housing positioned over the base, a mounting plate disposed within the interior cavity and secured to the base, and a pre-connectorized fiber optic drop cable optically connected to a connectorized optical fiber of a distribution cable through a connector port mounted on the mounting plate in accordance with another exemplary embodiment of the present invention;

FIG. 3 is a perspective view of an optical termination pedestal defining an interior cavity and including a base, a housing positioned over the base, a mounting plate secured to the housing, and a plurality of access doors operable for providing access to the interior cavity in accordance with another exemplary embodiment of the present invention;

FIG. 4 is a perspective view of an optical termination pedestal defining an interior cavity and including a base, a housing positioned over the base, a mounting plate secured to the housing or the base, and a sliding ring for providing access to a lower portion of the interior cavity in accordance with another exemplary embodiment of the present invention;

FIG. 5 is a perspective view of the optical termination pedestal of FIG. 4 with the sliding ring shown in a raised position to expose the lower portion of the interior cavity;

FIG. 6 is a perspective view of an optical termination pedestal defining an interior cavity and including a base, a housing positioned over the base, at least one access door for providing access to the interior cavity, a horizontal mounting plate secured to the housing, and a plurality of connector ports mounted on a vertical mounting plate in accordance with another exemplary embodiment of the present invention;

FIG. 7 is a perspective view of an optical termination pedestal defining an interior cavity and including a base, a housing positioned over the base, a plate secured to the housing and having a plurality of cable entrance and exit ports, and at least one optical fiber of a drop cable spliced to at least one optical fiber of a distribution cable in accordance with an exemplary embodiment of the present invention; and

FIG. 8 is a perspective view of an optical termination pedestal defining an interior cavity and including a base, a removable housing positioned over the base, a plate secured to the base and having a plurality of cable entrance and exit ports, and a means for interconnecting at least one connectorized optical fiber of a drop cable to at least one connectorized optical fiber of a distribution cable in accordance with another exemplary embodiment of the present invention.

### DETAILED DESCRIPTION OF THE INVENTION

The present invention will now be described more fully hereinafter with reference to the accompanying drawings in which exemplary embodiments of the invention are shown. This invention may, however, be embodied in many different forms and should not be construed as limited to the embodiments set forth herein. These exemplary embodiments are shown and described so that this disclosure will be both thorough and complete, and will fully convey the scope of the invention to those skilled in the art. Like reference numbers refer to like elements throughout the various drawings.

The present invention provides various embodiments of an optical termination pedestal defining an interior cavity adapted for housing fiber optic cables, terminated optical fibers and optical connections, and for sealing the terminated optical fibers and optical connections against adverse environmental conditions, such as dust, dirt, infestation and moisture, and in particular, a flood condition. The optical termination pedestal comprises a plate that is secured within the interior cavity defined by the pedestal and separates the interior cavity into a first compartment and a second compartment. At least one cable port is provided on the plate and is operable for passing a distribution cable therethrough. In the embodiments shown and described herein, the plate is provided with both a cable entrance port and a cable exit port for routing the distribution through the pedestal. The distribution cable enters and exits the pedestal at the lower end of the housing to form a “butt” or “canister” type pedestal. However, the manner in which the distribution cable is routed into, through and out of the pedestal depends on the configuration of the plate and whether the housing is positioned over a conventional pedestal base or over a base incorporated into a below-ground vault or hand hole. In several embodiments, one or more connector ports are mounted on the plate and operable for receiving connectorized optical fibers of the distribution cable on one side of the connector port and pre-connectorized fiber optic drop cables on the other side of the connector port. Each connector port may include a connector adapter sleeve disposed within the connector port or may be configured to receive the mating optical connectors in any manner now known or hereafter devised. Furthermore, the connector port may be configured to form an optical connection between optical fibers in any suitable manner. Regardless, each connector port is operable for establishing an optical connection between a connectorized optical fiber of the distribution cable and a respective optical fiber of a pre-connectorized drop cable.

In several of the embodiments illustrated herein, terminated optical fibers of the distribution cable are first connectorized and then routed to the connector ports in the first compartment of the interior cavity. The terminated optical fibers accessed from the distribution cable may be spliced to optical fibers having optical connectors mounted on the end (i.e., “pigtails”), which are then routed to the connector ports. Alternatively, a connector may be mounted directly on the end of the terminated optical fiber (i.e., direct connectorized) or a field-installable connector having a stub fiber may be fusion spliced or mechanically spliced to the terminated optical fiber. Other optical fibers of the distribution cable may be managed and routed separately from the terminated optical fibers such that they extend uninterrupted through the pedestal. Once the desired optical fibers are accessed, terminated, connectorized and routed to the connector ports, the housing may be positioned over the base and the first compartment sealed using the plate. One or more pre-connectorized drop cables are then routed to the other side of the connector ports from the second compartment of the housing at any time subsequent to the initial installation of the pedestal without requiring access to the first compartment. The size of the pedestal and the plate may vary depending upon the number of connector ports required, the minimum bend radius of the distribution cable, and the number of optical components and the amount of slack optical fiber stored within the pedestal. However, the diameter of the pedestal typically does not exceed about eight inches. In all embodiments, different distribution cable types may be accommodated, such as monotube, loose tube, central tube, ribbon and the like. In all embodiments, the connector ports may be adapted to accommodate a variety of connector types, such as but not limited to SC, LC, DC, FC, ST, SC/DC, MT-RJ, MTP and MPO ferrules.

In all embodiments shown and described herein, the plate disposed within the housing defines one or more cable entrance and exit ports for routing one or more fiber optic cables from the second compartment into the first compartment. In particular, the cable ports route the distribution cable into and out of the first compartment, and in some embodiments, also route at least one drop cable into the first compartment. One example of a type of distribution cable that may be used in conjunction with present invention is an ALTOS® dielectric cable available from Corning Cable Systems LLC of Hickory, N.C. The ALTOS® dielectric cable is a lightweight fiber optic cable designed for both conduit (buried) and aerial (lashed) installations. In another example, the distribution cable is a Standard Single-Tube Ribbon (SST-Ribbon™) cable available from Corning Cable Systems LLC of Hickory, N.C. The SST-Ribbon™ cable contains readily identifiable twelve-fiber ribbons in a gel-filled tube. Regardless, the distribution cable is preferably designed to provide stable performance over a wide range of temperatures and to be compatible with any telecommunications grade optical fiber. As used herein, the term “optical fiber” is intended to include all types of single mode and multi-mode light waveguides, including one or more bare optical fibers, coated optical fibers, loose-tube optical fibers, tight-buffered optical fibers, ribbonized optical fibers or any other expedient for transmitting light signals. In preferred embodiments, the distribution cable is flexible, easy to route and has no preferential bend. The distribution cable is routed into the housing through a pedestal base, for example, a base secured into the ground or a base incorporated into a below-grade vault or hand hole.

In a fiber optic communications network for use with the invention, one or more branch points are provided at mid-span access locations along the length of the distribution cable. The branch points may be created in the field by a known mid-span access procedure or may be created in the factory, such as a preterminated or pre-connectorized fiber optic distribution cable for a pre-engineered fiber optic network. At each mid-span access location, one or more optical fibers are identified, accessed, severed and branched from the distribution cable, resulting in one or more terminated optical fibers. In one embodiment, the terminated optical fibers are spliced directly to optical fibers of one or more drop cables. In other embodiments, the terminated optical fibers are first connectorized (i.e., an optical connector is mounted on the end of the terminated optical fiber). As previously described, the optical connector may be direct connectorized to the end of the terminated optical fiber. Alternatively, a field installable connector may be spliced (e.g., mechanically spliced or fusion spliced) to the terminated optical fiber. Still further, the terminated optical fiber may be first spliced to a short length of optical fiber having an optical connector attached at the other end (i.e., a pigtail). Regardless, the connectorized optical fibers of the distribution cable are routed to one side of a connector port and optically connected to respective optical fibers of a pre-connectorized drop cable on the other side of the connector port.

The mid-span access locations may be factory-prepared by skilled artisans in a controlled environment, or may be prepared in the field by a highly skilled field technician. In a factory-prepared mid-span access location, a portion of the cable sheath of the distribution cable is removed to expose a predetermined length of an underlying tubular body, such as a buffer tube, containing a plurality of optical fibers. Pre-selected optical fibers are then accessed from the tubular body and severed (i.e., preterminated) from the distribution cable. The mid-span access location may then be repaired and the preterminated optical fibers protected with a small form shipping and installation enclosure, which is preferably removed after the distribution cable is deployed. In a field-prepared mid-span access location, a portion of the cable sheath of the distribution cable is removed in the field by a highly skilled field technician (also referred to as a craftsman) to expose a predetermined length of an underlying tubular body, such as a buffer tube, containing a plurality of optical fibers. Pre-selected optical fibers are then accessed and terminated, and if desired, connectorized, as previously described. In both the factory-prepared and field-prepared mid-span access locations, the distribution cable and drop cables, the branch point, the terminated optical fibers, and the optical connections are routed, managed and protected within the housing. Typically, a pre-selected number of optical fibers of the distribution cable (e.g., four) are terminated for interconnection with optical fibers of one or more drop cables, while the remainder of the optical fibers extend uninterrupted through the optical termination pedestal to another mid-span access location.

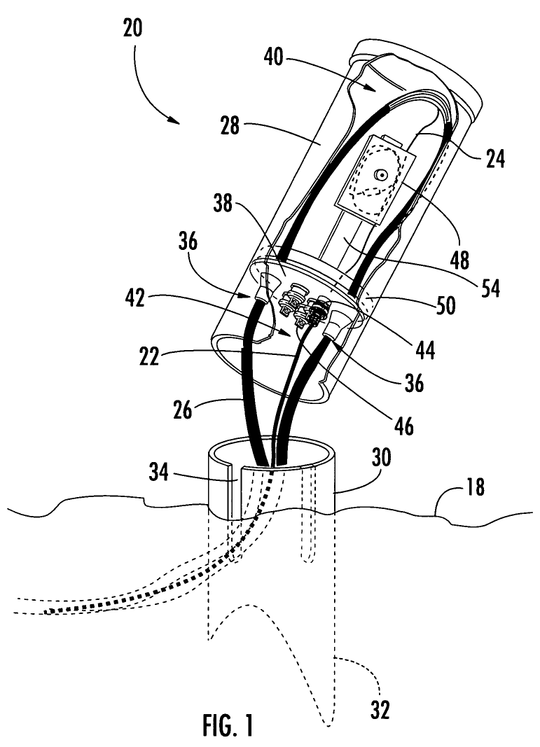

Referring now to FIG. 1, an optical termination pedestal 20 constructed in accordance with an exemplary embodiment of the present invention is shown. The optical termination pedestal 20, also referred to herein as pedestal 20, permits an optical fiber of one or more fiber optic drop cables 22 to be readily interconnected with a field-terminated or factory-preterminated optical fiber 24 of a fiber optic distribution cable 26. In this embodiment, the optical fiber 24 is also connectorized, and in particular, is spliced to a relatively short length of optical fiber having an optical connector mounted on the end (i.e., a pigtail). As is well known and understood in the art, each drop cable 22 comprises a flexible transport tube containing one or more optical fibers connected to an outside plant optical connection terminal, such as a network interface deice (NID) at a subscriber premises. As shown, the fiber optic drop cable 22 is pre-connectorized so that the drop cable 22 can be readily interconnected with the connectorized optical fiber 24 of the distribution cable 26, as will be described. Thus, the pedestal 20 provides a convenient branch point in a fiber optic network for a field technician to initially install and subsequently reconfigure optical connections between the distribution cable 26 and a pre-connectorized drop cable 22 to provide communications service to a subscriber.

The pedestal 20 shown in FIG. 1 typically extends only about two to three feet above the surface of the ground 18. A housing 28 is positioned over a conventional pedestal base 30 or onto a similar base incorporated into a below-grade vault or hand hole. The base 30 shown defines an integral stake feature 32 and is self-supporting. However, the base 30 and housing 28 may also be stake-mounted on the ground or pole-mounted above the ground. Both the base 30 and the housing 28 are preferably made of a flame, impact and UV-resistant material designed to provide security for the optical fiber terminations and to protect the optical fibers, optical connections and optical components in a buried plant environment. In addition, the pedestal 20 may be molded from resins designed to resist environmental degradation. The housing 28 is generally hollow so as to create a “bell-jar” effect when positioned over the base 30. As shown, the housing 28 is cylindrical in shape and has a relatively thin outer wall. However, the housing 28 may have any desired shape, such as square, rectangular, oval or irregular, and the outer wall may have any suitable thickness. In certain embodiments the housing 28 is removable so that 360 degree substantially unrestricted access is available to the field technician with the housing 28 removed. The bell-jar effect significantly reduces the likelihood that the optical fibers, optical connections and any electrical or optical components housed within the upper portion of the pedestal will be submerged in water in the event of a flood condition. The housing 28 may be secured to the base 30 using any suitable securing means, such as conventional fasteners or a bayonet type fitting, in a known manner.

The base 30 defines at least one slot 34 for permitting the distribution cable 26 and the one or more drop cables 22 to enter and exit the pedestal 20. The slot 34 allows the cables to be installed without having to trench deep into the ground below the bottom of the base 30. Accordingly, the ground in the immediate vicinity of the base 30 can be excavated by hand and the cables 26, 22 can enter the pedestal 20 through the slot 34 formed in the upper portion of the base 30. In an alternative embodiment (not shown), the distribution cable 26 and the one or more drop cables 22 may enter the pedestal 20 through the open bottom of the base 30, such as in a below-grade vault or hand hole installation. Additional slots 34 (indicated by dashed lines in FIG. 1) may be provided around the periphery of the base 30 to permit the distribution cable 26 and the one or more drop cables 22 to enter or exit the pedestal 20 at more convenient locations, or from different directions. The slots 34 may be initially covered by perforated tabs that are configured to be easily broken away from the base 30, as desired. The distribution cable 26 is routed from the base 30 into an interior cavity defined by the pedestal 20 within the housing 28. As shown, the distribution cable 26 is then routed to a cable port 36 provided on a mounting plate 38 secured to an interior wall of the housing 28 that separates the interior cavity into an upper first compartment 40 and a lower second compartment 42. The distribution cable 26 passes from the second compartment 42 through the cable port 36 into the first compartment 40, which houses the mid-span access location including the terminated optical fibers 24. The distribution cable 26 is then routed back to the mounting plate 38 and exits the first compartment 40 through another cable port 36 provided on the mounting plate 38 into the second compartment 42. The distribution cable 26 is preferably sealed and strain relieved at the cable entrance and exit ports 36 in a known manner. In an alternative embodiment, each cable opening 36 may be defined by two halves of a mounting plate that is brought together and secured around the distribution cable 26. If desired, conventional fasteners or epoxy adhesive may be used to secure the mounting plate to the interior wall of the housing 28 or around the distribution cable 26.

The mounting plate 38 is oriented generally perpendicular to the interior wall of the housing 28 (i.e., horizontal) and is shaped to conform to the contour of the interior wall. As shown, the housing is cylindrical shaped and has a relatively thin, constant thickness wall. Accordingly, the mounting plate 38 is circular shaped and may be provided with an 0-ring or other type seal (not shown) around its outer edge to seal between the mounting plate 38 and the interior wall of the cylindrical housing 28. Preferably, the mounting plate 38 is secured to the underside of an annular ring 50 affixed to the interior wall of the housing 28. A rubber gasket or other type seal (not shown) may be positioned between the underside of the ring 50 and the mounting plate 38. In the embodiment shown in FIG. 1, the mounting plate 38 serves as a bulkhead having a plurality of connector ports 44 mounted on the mounting plate 38. Unoccupied ports may be sealed using caps or plugs 46 until needed. As will be appreciated, the configuration and the size of the mounting plate 38 will vary depending on the number of connector ports 44, the number and size of the cable ports 36 and the inner diameter of the housing 28.

The exemplary embodiment illustrated in FIG. 1 comprises five connector ports 44 for interconnecting up to five pre-connectorized drop cables 22 to terminated and connectorized optical fibers 24 of the distribution cable 26. Although five connector ports 44 are shown in this particular embodiment, it is envisioned that the housing 28 and the mounting plate 38 may be designed to accommodate any number of connector ports 44. Typically, however, the housing 28 and the mounting plate 38 are configured with no less than four and no more than twelve connector ports 44. Thus, it is conceivable that the pedestal 20 may accommodate any number of pre-connectorized drop cables 22, for example, one, two, three, four, six, eight, twelve, etc. As used herein, the term “connector port” is intended to include an opening through the mounting plate 38 at which the connector mounted upon the end of the terminated and connectorized optical fiber 24 of the distribution cable 26 is optically connected to the connector of a pre-connectorized drop cable 22. The connector port 44 may also include a factory-installed connector housing and connector adapter sleeve (not shown) for aligning and maintaining the mating connectors in physical contact. In one embodiment, the connector adapter sleeve may be biased within the adapter to ensure physical contact between the opposed end faces of the connectors. Preferably, the connector ports 44 further provide an environmental seal at the optical connection between the connectorized optical fiber 24 of the distribution cable 26 and the pre-connectorized drop cable 22. The connector ports 44 also transfer any tension load of the cables on each side of the connector ports 44 to a connector port mounting, which in turn transfers any tension load to the mounting plate 38 and the housing 28.

As stated above, the pedestal 20 defines an interior cavity for housing the mounting plate 38, the distribution cable 26, connectorized optical fibers 24, one or more drop cables 22 and any optical components needed to connectorize optical fibers of the distribution cable 26, or to couple an optical fiber of the distribution cable 26 with an optical fiber of the drop cable 22. For example, the optical components may comprise a coupler, an adapter, an optical fiber routing guide, a slack storage hub, or the like. As shown, the optical components comprise a conventional splice tray 48 mounted on a bracket 54 secured to the ring 50. The splice tray 48 and bracket 54 may also be secured to the mounting plate 38 so that the splice tray 48 may be inserted into and removed from the interior cavity in conjunction with the mounting plate 38. Regardless, the mounting plate 38 separates the interior cavity into the first compartment 40 and the second compartment 42, as previously described. The mid-span access location, the connectorized optical fibers 24 and the optical components are housed within the first compartment 40. The second compartment 42 provides access to the connector ports 44 on the underside of the mounting plate 38 to which the drop cables 22 are connected. The optical fibers 24 of the distribution cable 26 are terminated at the mid-span access location and spliced to the connectorized optical fibers within the splice tray 48 in the first compartment 40. The terminated and connectorized optical fibers 24 are then routed to and connected to the connector ports 44 on the upper side of the mounting plate 38 within the first compartment 40. Thus, the first compartment 40 serves the same function as, and replaces, a conventional splice closure having a plurality of cable entrance and exit ports and a plurality of connector ports in an end wall for interconnecting optical fibers 24 of the distribution cable 26 with respective optical fibers of one or more drop cables 22. With the mounting plate 38 sealed against the interior wall of the housing 28 and the ring 50, and with the cable ports 36 and connector ports 46 sealed as previously mentioned, the mounting plate 38 serves to substantially seal the first compartment 40 relative to the second compartment 42. In particular, the first compartment 40 forms a first air pocket, preferably at a slightly higher air pressure than the second compartment 42. The second compartment 42 forms a second air pocket below the first air pocket when the housing 28 is positioned over the base 30. With the housing 28 positioned over the base 30, the second compartment 42 creates a “bell jar” effect that further acts to prevent water from entering the first compartment 40. In particular, water entering the interior cavity at the base 30 of the pedestal 20 compresses the air in the second compartment 42 upwardly, thereby increasing the pressure in the second compartment 42 relative to the ambient pressure outside the pedestal 20. Thus, a substantially sealed “splice closure” is created inside the pedestal 20 without the need for an additional enclosure to be housed within the interior cavity defined by the pedestal. As a result, the overall size of the optical termination pedestal 20 may be maintained smaller, or a greater number of drop cables may be interconnected within a pedestal of the same size.

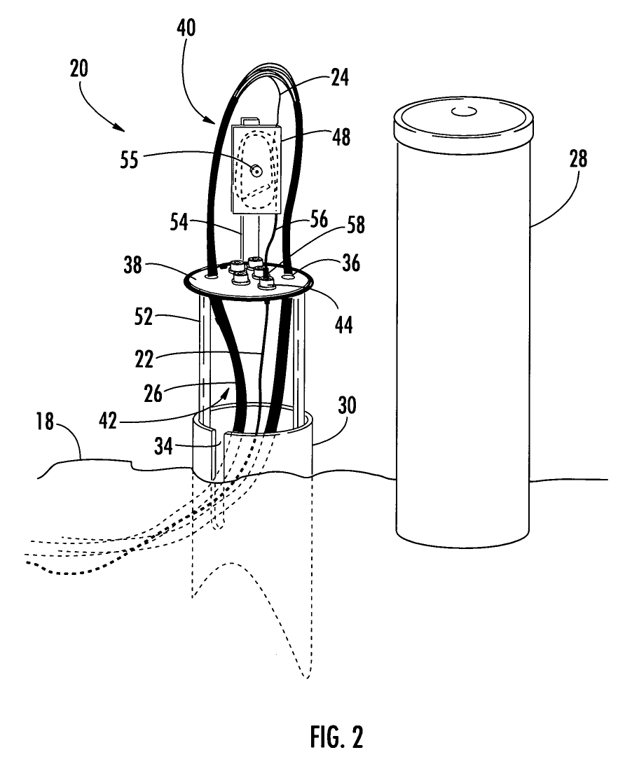

Referring to FIG. 2, an optical termination pedestal 20 constructed in accordance with another exemplary embodiment of the present invention is shown. In this embodiment, the mounting plate 38 is secured to the base 30, instead of being secured to the housing 28 as in the previous embodiment. Thus, the housing 28 is removable from the mounting plate 38 and the base 30. As previously described, the distribution cable 26 enters the first compartment 40 through a cable port 36 provided in the mounting plate 38, and exits the first compartment through another cable port 36 provided in the mounting plate 38. At least one, and preferably a plurality of mounting brackets 52 affix the mounting plate 38 to the base 30. As previously described, a bracket 54 secures a conventional splice tray 48 to the mounting plate 38. It will be readily apparent and well understood by one of ordinary skill in the art that inside the splice tray 48, a terminated optical fiber 24 of the distribution cable 26 is spliced to a relatively short length of optical fiber having a connector mounted on the end (i.e., a pigtail 56) in any known manner, such as by fusion splicing or mechanical splicing. The splice tray 48 is adapted to receive any number of splices. Furthermore, more than one splice tray 48 may be provided to accommodate splicing additional optical fibers 24 of the distribution cable 26 to pigtails 56. In the case of more than one splice tray 48, the splice trays may be positioned in a stacked relationship and retained in a known manner, such as by a strap, or as shown, by a nut 55 secured on a threaded mounting post. The bracket 54 may also be used to secure other optical components to the mounting plate 38, such as couplers, adapters, optical fiber routing guides, slack storage hubs and the like. Strain relief members (not shown) may also be secured to the mounting plate 38 or to the brackets 52, 54. The strain relief members provide strain relief for the distribution cable 26 or the fiber optic drop cables 22 within the interior cavity defined by the pedestal 20.

While the mounting plate 38 depicted in FIG. 1 is attached to the housing 28 and remains with the housing 28 when the housing 28 is separated from the base 30, the mounting plate 38 depicted in FIG. 2 is attached to the base 30 and remains with the base 30 when the housing 28 is removed from the base 30. As a result, a field technician is provided with 360 degree substantially unrestricted access to the mid-span access location, including terminated optical fibers 24, splice tray 48, pigtails 56, and cable ports 36 and connector ports 44 on the mounting plate 38, when the housing 28 is removed. As previously described with respect to the embodiment shown in FIG. 1, pigtail 56 is routed within the first compartment 40 of the housing 28 and connector 58 is connected to one side of a connector port 44. With the housing 28 removed as shown, the interior cavity of the pedestal 20 is readily accessible to a field technician initially installing the pigtails 56 and connectors 58 into the respective connector ports 44. The field technician may create and route additional pigtails 56 and connectors 58 to the unused connector ports 44 for future use, or may remove or rearrange existing optical connections between previously installed connectors 58 and the connector ports 44. Once the pedestal 20 is initially installed, the field technician may also add, remove or rearrange optical connections between optical fibers of the pre-connectorized drop cables 22 and the other side of the respective connector ports 44. Thus, additional drop cables can be connected to the unused connector ports 44 without disturbing the previously installed pigtails 56 and connectors 58. As previously described, an O-ring or other seal is provided on the outer edge of the mounting plate 38 to substantially seal the first compartment 40 relative to the second compartment 42 when the housing 28 is positioned over the base 30. As in the previous embodiment, the second compartment 42 creates a “bell jar” effect that further acts to prevent water from entering the first compartment 40. Thus, a substantially sealed splice closure is created inside the pedestal 20 without the need for an additional enclosure to be housed within the interior cavity defined by the pedestal 20. As a result, the overall size of the optical termination pedestal 20 may be maintained smaller, or a greater number of drop cables may be interconnected within a pedestal of the same size.

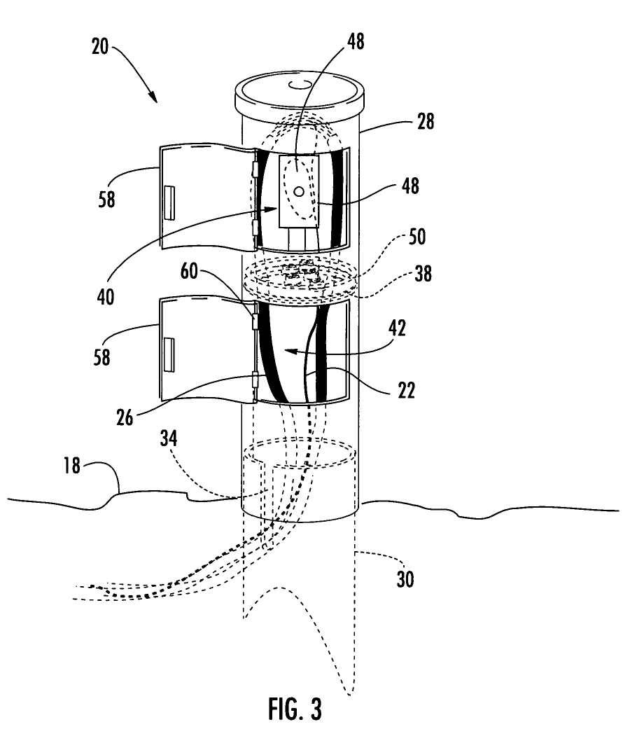

Referring to FIG. 3, an optical termination pedestal 20 constructed in accordance with another exemplary embodiment of the present invention is shown with one or more access doors 58 in an opened position. Preferably, the access doors 58 are hingedly affixed to the housing 28 at one or more hinge locations 60. Regardless, the access doors 58 are movable between an opened position for providing access to the first and second compartments 40, 42 within the interior cavity defined by the pedestal 20, and a closed position for securing and sealing the interior cavity defined by the pedestal 20. The access doors 58 are operable for providing access for a field technician to initially configure the pedestal 20 or to subsequently add, remove or reconfigure optical connections. Any optical components within the interior cavity are positioned so as to not interfere with the movement of the access doors 58 between the opened and closed positions. As shown, the access doors 58 are rotatable relative to the housing 28 through an angle of at least about 90 degrees and as much as about 180 degrees between the opened position and the closed position, thus providing convenient and substantially unrestricted access to the first compartment 40 and the second compartment 42 within the interior cavity. Alternatively, the access doors 58 may be removably attached to the housing 28 to provide unobstructed access to the interior cavity. The access doors 58 may be provided with a security lock or other means for securing the access doors 58 in the closed position, thereby deterring unauthorized persons from accessing the interior cavity defined by the pedestal 20. Furthermore, the outer edge of the access doors 58 may be provided with a rubber gasket or other seal for sealing the interior cavity against adverse environmental conditions, such as dust, dirt, infestation and moisture. As previously described, an O-ring or other seal is provided on the outer edge of the mounting plate 38 to substantially seal the first compartment 40 relative to the second compartment 42 when the housing 28 is positioned over the base 30. As in the previous embodiments, the second compartment 42 creates a “bell jar” effect that further acts to prevent water from entering the first compartment 40. Thus, a substantially sealed splice closure is created inside the pedestal 20 without the need for an additional enclosure to be housed within the interior cavity defined by the pedestal 20. As a result, the overall size of the optical termination pedestal 20 may be maintained smaller, or a greater number of drop cables may be interconnected within a pedestal of the same size.

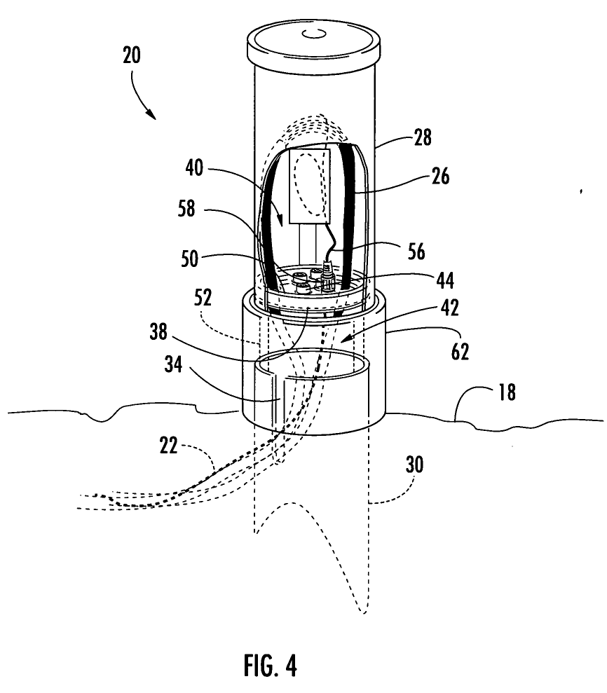

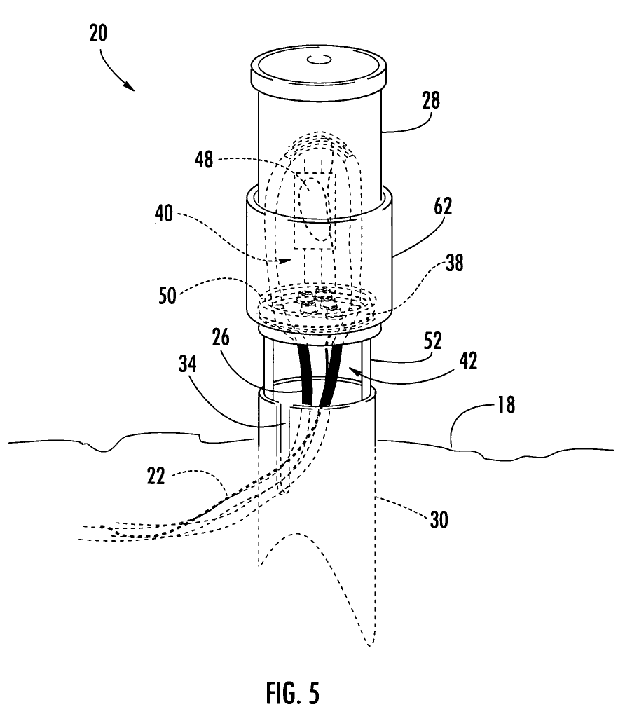

Referring to FIGS. 4 and 5, a pedestal 20 constructed in accordance with another exemplary embodiment of the present invention is shown with a sliding ring 62 that is movable between a closed position and an opened position. The ring 62 overlaps a lower portion of the housing 28 and an upper portion of the base 30 and is configured so that it may be moved up and down relative to the base 30 and the housing 28 to provide substantially unrestricted access to the second compartment 42 within the interior cavity defined by the pedestal 20 from below the housing 28. The ring 62 is shown in the lowered and closed position in FIG. 4, and is shown in the raised and opened position in FIG. 5. The access to the second compartment 42 provided by the ring 62 allows a field technician to readily connect a pre-connectorized drop cable 22 to one side of a connector port 44 on the underside of the mounting plate 38. The housing 28 is supported at a predetermined position above the base 30 by one or more brackets 52 and the mounting plate 38 is preferably secured to a ring 50 affixed to the interior wall of the housing 28. As previously described, an O-ring or other seal is provided on the outer edge of the mounting plate 38 to substantially seal the first compartment 40 relative to the second compartment 42 when the housing 28 is positioned over the base 30. As in the previous embodiments, the second compartment 42 creates a “bell jar” effect (with the ring 62 in the lowered and closed position) that further acts to prevent water from entering the first compartment 40. Thus, a substantially sealed splice closure is created inside the pedestal 20 without the need for an additional enclosure to be housed within the interior cavity defined by the pedestal 20. As a result, the overall size of the optical termination pedestal 20 may be maintained smaller, or a greater number of drop cables may be interconnected within a pedestal of the same size.

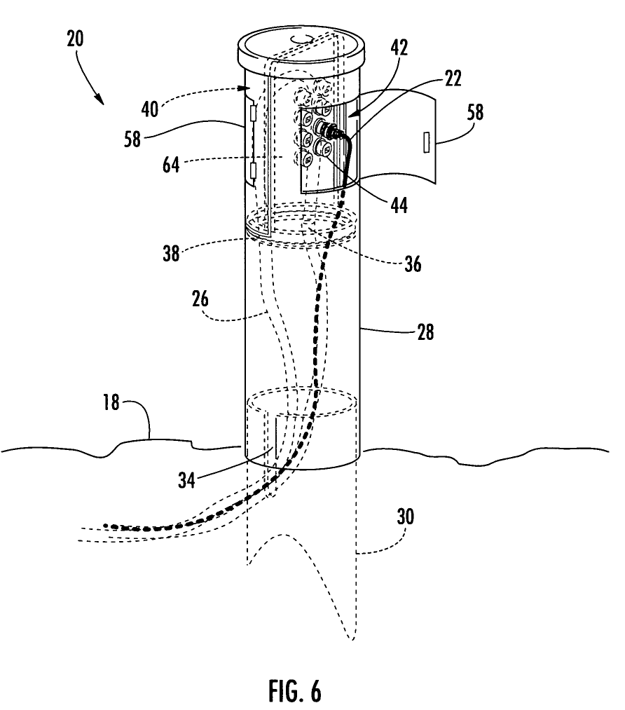

Referring to FIG. 6, a pedestal 20 constructed in accordance with another exemplary embodiment of the present invention is shown with a plurality of connector ports 44 mounted on a vertical mounting plate 64. In this embodiment, the mounting plate 38 is oriented generally perpendicular to the interior wall of the housing 28 (i.e., horizontal) as in the previous embodiments. However, the pedestal 20 further comprises a vertical mounting plate 64 affixed to the upper side of the mounting plate 38 and extending upwardly to the underside of the housing 28. Instead of separating the interior cavity defined by the pedestal 20 into an upper first compartment 40 and a lower second compartment 42 with a horizontal mounting plate 38, the interior cavity is separated into a forward first compartment 40 and a rearward second compartment 42 by the vertical mounting plate 64 so that the first and second compartments 40, 42 are arranged side by side within the upper portion of the housing 28. The mounting plate 38 has a pair of sealed cable entrance and exit ports 36 for receiving the distribution cable 26 and routing the distribution cable 26 into and out of the first compartment 40. The mounting plate 38 further has at least one, and preferable a plurality of drop cable openings (obscured) for passing one or more pre-connectorized fiber optic drop cables 22 into the second compartment 42. Any empty drop cable openings in mounting plate 38 may be fitted with a cap or plug (not shown) so that the second compartment 42 is protected against dirt, dust and infestation. One or more access doors 58 may be hingedly affixed to the housing 28, thus allowing the access doors 58 to be rotated between an opened position for providing access to the first and second compartments 40, 42, and a closed position for sealing and securing the pedestal 20. As previously stated, the access doors 58 are operable for providing substantially unrestricted access to a field technician initially installing the pedestal 20 or subsequently reconfiguring the optical connections.

The distribution cable 26 is routed through a slot 34 provided in the base 30 and into the interior cavity defined by the pedestal 20. The distribution cable 26 is then routed through one of the cable ports 36 provided on the mounting plate 38 and into the first compartment 40 so that the mid-span access location on the distribution cable 26 is housed within the first compartment 40. The terminated optical fibers of the distribution cable 26 are then connectorized and routed to one side of the connector ports 44 from the first compartment 40. The distribution cable 26 exits the first compartment 40 through the other cable port 36 and exits the pedestal 20 through the slot 34 provided in the base 30. The distribution cable 26 is preferably sealed and strain relieved at the cable ports 36 in any suitable and known manner. The pre-connectorized drop cables 22 are likewise routed through a slot 34 provided in the base 30 and into the interior cavity defined by the pedestal 20. The drop cables 22 are then routed into the second compartment 42 through the drop cable openings provided in the mounting plate 38. The pre-connectorized drop cables 22 are then connected to the other side of the connector ports 44 from the second compartment 42. At least a portion of the horizontal mounting plate 38 and the vertical mounting plate 64 are provided with an O-ring or other seal along their outer edges to seal the respective portions of the mounting plate 38 and the mounting plate 64 to the interior wall and the underside of the housing 28. As shown, only the semi-circular portion of the mounting plate 38 adjacent the first compartment 40 is provided with an O-ring or other seal so that the terminated optical fibers, any optical components and the optical connections within the first compartment 40 are sealed against adverse environmental conditions, such as dust, dirt, infestation and moisture, and in particular a flood condition. Typically, the optical connections in the second compartment 42 between the pre-connectorized drop cables 22 and the connector ports 44 are sealed in a suitable manner. However, if desired, the entire outer edge of the horizontal mounting plate 38 may be provided with an O-ring or other seal to further protect the optical connections within the second compartment 42. The O-ring or other seal provided on the outer edge of the mounting plate 38 and the mounting plate 64 substantially seals the first compartment 40 relative to the second compartment 42 when the housing 28 is positioned over the base 30. In this embodiment, the interior cavity below the first and second compartments 40, 42 creates a “bell jar” effect (with the mounting plate 38 secured to the interior wall of the housing 28) that further acts to prevent water from entering the first compartment 40. Thus, a substantially sealed splice closure is created inside the pedestal 20 without the need for an additional enclosure to be housed within the interior cavity defined by the pedestal 20. As a result, the overall size of the optical termination pedestal 20 may be maintained smaller, or a greater number of drop cables may be interconnected within a pedestal of the same size.

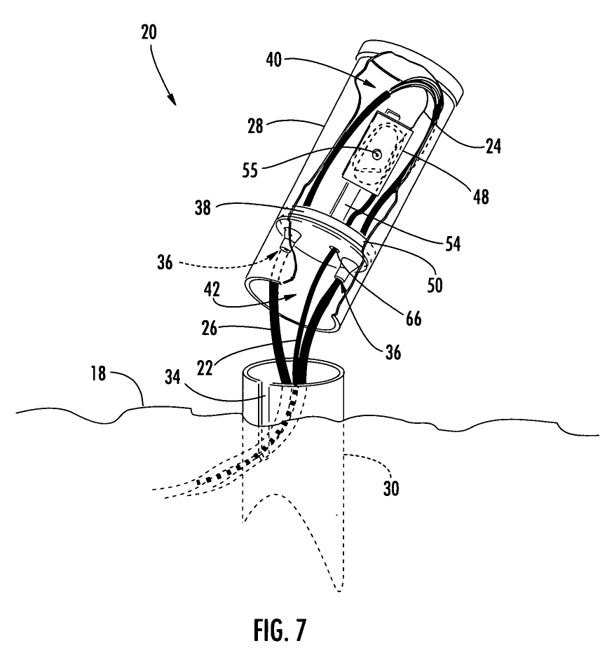

Referring to FIG. 7, an optical termination pedestal 20 constructed in accordance with another exemplary embodiment of the present invention is shown. The pedestal 20 permits an optical fiber of one or more fiber optic drop cables 22 to be spliced in the field with a field-terminated or factory-preterminated optical fiber 24 of a fiber optic distribution cable 26. In this embodiment, the terminated optical fiber 24 is not connectorized. As is well known and understood in the art, a terminated or preterminated optical fiber 24 of the distribution cable 26 and an optical fiber of a drop cable 22 may be fusion or mechanically spliced and retained within a conventional splice tray 48 adapted to receive any number of splices. In the case of more than one splice tray 48, the splice trays 48 may be positioned in a stacked relationship and retained in a known manner, such as by a strap, or as shown by a nut 55 secured on a threaded mounting post. A bracket 54 may be used to secure the splice tray 48, as well as other optical components, such as couplers, adapters, optical fiber routing guides, slack storage hubs and the like, to the mounting plate 38.

The distribution cable 26 is routed through a slot 34 provided in the base 30 and into the interior cavity defined by the pedestal 20. The distribution cable 26 is then routed through one of the cable ports 36 provided on the mounting plate 38 and into the first compartment 40 so that the mid-span access location on the distribution cable 26 is housed within the first compartment 40. The field-terminated or factory-preterminated optical fibers 24 of the distribution cable 26 are then routed to the splice tray 48 within the first compartment 40. The distribution cable 26 exits the first compartment 40 through the other cable port 36 and exits the pedestal 20 through the slot 34 provided in the base 30. The distribution cable 26 is preferably strain relieved at the cable ports 36 in any suitable and known manner. The fiber optic drop cables 22 are likewise routed through a slot 34 provided in the base 30 and into the interior cavity defined by the pedestal 20. The drop cables 22 are then routed into the first compartment 40 through one or more drop cable openings 66 provided in the mounting plate 38. The drop cables 22 are next routed into the splice tray 48 and mechanically or fusion spliced to the terminated or preterminated optical fibers 24 of the distribution cable 26 in a known manner. The cable ports 36 and the drop cable openings 66 are sealed in any suitable and known manner. The mounting plate 38 is provided with an O-ring or other seal along the outer edge to seal the mounting plate 38 to the interior wall of the housing 28 so that the first compartment 40 is protected against adverse environmental conditions, such as dust, dirt, infestation and moisture, and in particular a flood condition. The O-ring or other seal provided on the outer edge of the mounting plate 38 substantially seals the first compartment 40 relative to the second compartment 42 when the housing 28 is positioned over the base 30. As in previous embodiments, the second compartment 42 creates a “bell jar” effect (with the mounting plate 38 secured to the interior wall of the housing 28) that further acts to prevent water from entering the first compartment 40. Thus, a substantially sealed splice closure is created inside the pedestal 20 without the need for an additional enclosure to be housed within the interior cavity defined by the pedestal 20. As a result, the overall size of the optical termination pedestal 20 may be maintained smaller, or a greater number of drop cables may be interconnected within a pedestal of the same size.

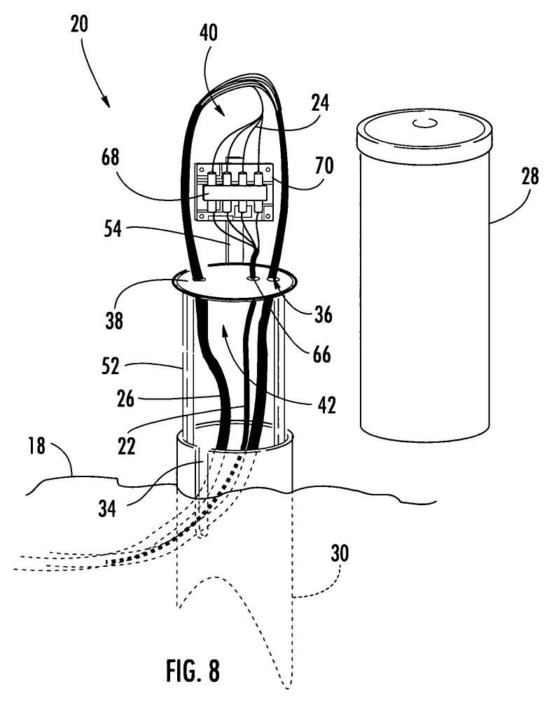

Referring to FIG. 8, an optical termination pedestal 20 constructed in accordance with another exemplary embodiment of the present invention is shown. The pedestal 20 permits an optical fiber of one or more fiber optic drop cables 22 to be optically connected with a field-terminated or factory-preterminated optical fiber 24 of a fiber optic distribution cable 26. In this embodiment, the terminated or preterminated optical fibers 24 are direct connectorized. Alternatively, a field-installable connector may be fusion spliced or mechanically spliced onto the ends of the optical fibers 24 in a known manner. The optical fibers of the drop cables 22 are pre-connectorized, or alternatively, a field-installable connector is likewise fusion spliced or mechanically spliced onto the ends of the optical fibers of the drop cables 22. As is well known and understood in the art, a connectorized optical fiber 24 of the distribution cable 26 and a connectorized optical fiber of a drop cable 22 may be optically connected by a means for interconnecting, for example, a conventional connector adapter sleeve 68. As shown, a plurality of connector adapter sleeves 68 may be positioned in a linear arrangement and retained in a known manner, such as by a strap or other fastener. A bracket 54 may be used to secure the connector adapter sleeves 68, as well as any other passive or active electrical, optical or electro-optical components 70, such as a power source, printed circuit board, splitter, amplifier, division wave multiplexer (DWM), or the like, to the mounting plate 38. The mounting plate 38 in turn may be secured to the base 30 by at least one bracket 52 so that the housing 28 can be removed from the base 30 to provide a field technician with essentially unobstructed access to the first compartment 40 and the second compartment 42 within the interior cavity defined by the pedestal 20.

The distribution cable 26 is routed through a slot 34 provided in the base 30 and into the interior cavity defined by the pedestal 20. The distribution cable 26 is then routed through one of the cable ports 36 provided on the mounting plate 38 and into the first compartment 40 so that the mid-span access location on the distribution cable 26 is housed within the first compartment 40. The terminated or preterminated optical fibers 24 of the distribution cable 26 are then connectorized and routed into one side of the connector sleeve adapters 68 within the first compartment 40. The distribution cable 26 exits the first compartment 40 through the other cable port 36 and exits the pedestal 20 through the slot 34 provided in the base 30. The distribution cable 26 is preferably strain relieved at the cable ports 36 in any suitable and known manner. The fiber optic drop cables 22 are likewise routed through a slot 34 provided in the base 30 and into the interior cavity defined by the pedestal 20. The drop cables 22 are then routed into the first compartment 40 through one or more drop cable openings 66 provided in the mounting plate 38. The drop cables 22 are next connectorized (if not pre-connectorized) and routed into the other side of the connector adapter sleeves 68 so that optical fibers of the drop cables 22 are optically connected to the connectorized optical fibers 24 of the distribution cable 26 in a known manner. The cable ports 36 and the drop cable openings 66 are sealed in any suitable and known manner. The mounting plate 38 is provided with an O-ring or other seal along the outer edge to seal the mounting plate 38 to the interior wall of the housing 28 so that the first compartment 40 is protected against adverse environmental conditions, such as dust, dirt, infestation and moisture, and in particular a flood condition. The O-ring or other seal provided on the outer edge of the mounting plate 38 substantially seals the first compartment 40 relative to the second compartment 42 when the housing 28 is positioned over the base 30. As in previous embodiments, the second compartment 42 creates a “bell jar” effect (with the housing 28 positioned over the mounting plate 38 and the base 30) that further acts to prevent water from entering the first compartment 40. Thus, a substantially sealed splice closure is created inside the pedestal 20 without the need for an additional enclosure to be housed within the interior cavity defined by the pedestal 20. As a result, the overall size of the optical termination pedestal 20 may be maintained smaller, or a greater number of drop cables may be interconnected within a pedestal of the same size.

In all embodiments described above, the pedestal 20 may be either sealed or ventilated. In a further embodiment, the same concept of combining the functions of a conventional splice closure and a conventional pedestal may be applied to a below-grade vault or hand hole installation. In a particular example, a below-grade vault may incorporate a plate or bulkhead for mounting the connector ports and provide a splicing compartment so that a splice closure having a separate enclosure inside the vault is not required. In a still further embodiment, the base may be designed with a plate or bulkhead affixed to an interior wall of the base such that the connector ports can be exposed when the housing is lifted off the base.

The exemplary embodiments of an optical termination pedestal according to the present invention shown and described herein provide a number of significant advantages over previously known pedestals that contain conventional splice closure. For purposes of example only, and not by way of limitation, a pedestal constructed in accordance with the invention provides a field technician with the ability to readily connect, disconnect and reconfigure pre-connectorized fiber optic drop cables to “quick connect” connector ports located within an interior cavity defined by the pedestal. In addition, connectorized optical fibers of the distribution cable can be routed to the connector ports during initial installation and retained within a substantially sealed first compartment. Thereafter, a field technician is not required to enter the sealed first compartment to make subsequent optical connections of the pre-connectorized drop cables to the terminated or preterminated optical fibers of the distribution cable. Thus, the pedestal of the present invention eliminates the need to perform fusion or mechanical splices in the field once the optical fibers of the distribution cable are terminated and connectorized. It should be noted that a pedestal constructed in accordance with the invention permits terminated or preterminated optical fibers of a distribution cable to be interconnected with respective optical fibers of one or more drop cables in numerous different configurations.

The foregoing is a description of various embodiments of the invention that are given here by way of example only. Although optical termination pedestals have been described with reference to preferred embodiments and examples thereof, other embodiments and examples may perform similar functions and/or achieve similar results. All such equivalent embodiments and examples are within the spirit and scope of the present invention and are intended to be covered by the appended claims.

1. An optical termination pedestal defining an interior cavity and comprising:
a base;
a housing positioned over the base;
a distribution cable received within the interior cavity;
at least one drop cable received within the interior cavity;
a plate secured to one of the housing and the base and operable for separating the interior cavity into a first compartment and a second compartment; and
a means for interconnecting at least one optical fiber of the distribution cable to at least one optical fiber of the drop cable.

2. An optical termination pedestal according to claim 1, wherein the plate has at least one cable port for routing the distribution cable into and out of the first compartment.

3. An optical termination pedestal according to claim 2, wherein the at least one optical fiber of the distribution cable is spliced to the at least one optical fiber of the drop cable in the first compartment.

4. An optical termination pedestal according to claim 3 wherein the means for interconnecting comprises at least one splice tray.

5. An optical termination pedestal according to claim 2, wherein the at least one optical fiber of the distribution cable is connectorized and optically connected to the means for interconnecting in the first compartment and wherein the at least one optical fiber of the drop cable is connectorized and optically connected to the means for interconnecting in the first compartment.

6. An optical termination pedestal according to claim 5 wherein the means for interconnecting comprises a connector adapter sleeve.

7. An optical termination pedestal according to claim 2, wherein the optical fiber of the distribution cable is terminated and connectorized in the first compartment and the drop cable is pre-connectorized.

8. An optical termination pedestal according to claim 2, wherein the plate comprises a mounting plate having at least one connector port mounted thereon and wherein the optical fiber of the distribution cable is optically connected to the means for interconnecting in the first compartment and the drop cable is optically connected to the means for interconnecting in the second compartment.

9. An optical termination pedestal according to claim 8, wherein the optical fiber of the distribution cable is terminated and connectorized in the first compartment and the drop cable is pre-connectorized.

10. An optical termination pedestal according to claim 8, wherein the optical fiber of the distribution cable is terminated and spliced to a pigtail in the first compartment and the drop cable is pre-connectorized.

11. An optical termination pedestal according to claim 1, wherein the plate comprises a seal adjacent an interior wall of the housing for substantially sealing the first compartment relative to the second compartment.

12. An optical termination pedestal according to claim 1, wherein the second compartment creates a bell jar effect when the housing is positioned over the base to further seal the interior cavity relative to the ambient atmosphere.

13. An optical termination pedestal according to claim 1, further comprising one or more access doors on the housing movable between an opened position and a closed position for providing access to at least one of the first compartment and the second compartment.

14. An optical termination pedestal according to claim 1, further comprising a first access door on the housing for providing access to the first compartment and a second access door on the housing for providing access to the second compartment.

15. An optical termination pedestal according to the claim 1, further comprising a sliding ring movable between a closed position and an opened position for providing access to a lower portion of the interior cavity.

16. An optical termination pedestal according to claim 1, wherein the plate is secured to the base and the housing is removable.

17. An optical termination pedestal defining an interior cavity for interconnecting at least one terminated optical fiber of a distribution a cable with at least one optical fiber of a fiber optic drop cable, the pedestal comprising:
a base;
a housing positioned over the base;
a distribution cable received within the interior cavity;
at least one drop cable received within the interior cavity; and
a plate secured to one of the housing and the base and operable for separating the interior cavity into a first compartment and a second compartment.

18. An optical termination pedestal according to claim 17, wherein the plate is provided with a seal adjacent an interior wall of the housing to substantially seal the first compartment relative to the second compartment.

19. An optical termination pedestal according to claim 17, wherein the second compartment creates a bell jar effect when the housing is positioned over the base to further seal the interior cavity relative to the ambient atmosphere.

20. An optical termination pedestal according to claim 17, wherein the plate has at least one cable port for routing the distribution cable into and out of the first compartment and wherein the pedestal further comprises means for interconnecting the at least one terminated optical fiber of the distribution cable and the at least one optical fiber of the drop cable.

21. An optical termination pedestal according to claim 20, wherein the means for interconnecting comprises at least one splice tray and wherein the at least one terminated optical fiber of the distribution cable is spliced to the at least one optical fiber of the drop cable within the splice tray in the first compartment.

22. An optical termination pedestal according to claim 20, wherein the means for interconnecting comprises at least one connector sleeve adapter and wherein the at least one terminated optical fiber of the distribution cable is connectorized and optically connected to the at least one optical fiber of the drop cable through the at least one connector adapter sleeve in the first compartment.

23. An optical termination pedestal according to claim 20, wherein the means for interconnecting comprises at least one connector port mounted on the plate and wherein the at least one terminated optical fiber of the distribution cable is connectorized and routed to the at least one connector port in the first compartment.

24. An optical termination pedestal according to claim 20, wherein the at least one terminated optical fiber of the distribution cable is connectorized, wherein the at least one optical fiber of the drop cable is connectorized, wherein the means for interconnecting comprises at least one connector port mounted on the plate, and wherein the terminated and connectorized optical fiber of the distribution cable is optically connected to the connectorized optical fiber of the drop cable through the at least one connector port.

25. An optical termination pedestal according to claim 17, further comprising one or more access doors on the housing movable between an opened position and a closed position for providing access to at least one of the first compartment and the second compartment.

26. An optical termination pedestal according to the claim 17, further comprising a sliding ring movable between a closed position and an opened position for providing access to a lower portion of the interior cavity.

27. An optical termination pedestal according to claim 17, wherein the plate is secured to the base and the housing is removable.

28. An optical termination pedestal for use at a branch point in a fiber optic communications network, the pedestal defining an interior cavity and comprising:
a base;
a housing positioned over the base;
a plate secured to one of the housing and the base and operable for separating the interior cavity into a first compartment and a second compartment, the plate having at least one cable port for routing a distribution cable into and out of the first compartment; and
a means for interconnecting a terminated optical fiber of the distribution cable and an optical fiber of a drop cable in one of the first compartment and the second compartment;
wherein the plate creates a splice closure within the pedestal without the use of a separate enclosure.

29. An optical termination pedestal according to claim 28, wherein the means for interconnecting comprises at least one splice tray and wherein the terminated optical fiber of the distribution cable is spliced to the optical fiber of the drop cable within the at least one splice tray in the first compartment.

30. An optical termination pedestal according to claim 28, wherein the means for interconnecting comprises at least one connector adapter sleeve, wherein the terminated optical fiber of the distribution cable and the optical fiber of the drop cable are connectorized, and wherein the terminated and connectorized optical fiber of the distribution cable is optically connected to the connectorized optical fiber of the drop cable through the at least one connector adapter sleeve in the first compartment.

31. An optical termination pedestal according to claim 28, wherein the means for interconnecting comprises at least one connector port mounted on the plate, the terminated optical fiber of the distribution cable and the optical fiber of the drop cable are connectorized, and wherein the terminated and connectorized optical fiber of the distribution cable is optically connected in the first compartment to the connectorized optical fiber of the drop cable in the second compartment through the at least one connector port.
